(19) United States
(12) Patent Application Publication
(10) Pub. No.: US 2007/0149275 A1
(43) Pub. Date: Jun. 28, 2007

(54) GAMING MACHINE

(75) Inventors: Hideaki Iwamoto, Tokyo (JP); Tomohiro Shinoda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/616,117

(22) Filed: Dec. 26, 2006

(30) Foreign Application Priority Data
Dec. 27, 2005 (JP) P2005-376231

(51) Int. Cl. A63F 13/00

(52) U.S. Cl. 463/20

(57) ABSTRACT

A gaming machine comprising: a display having a symbol display area in which areas respectively displaying symbols are arranged in a matrix; and a processor that is operable to execute a first game and a second game executed if stopped symbol in the first game satisfies a predetermined condition. The processor is operable with the display to: variably display the symbols in each column of the symbol display area in a vertical direction if the first game is executed; and variably display the symbols in a first column of the symbol display area in a horizontal direction, and variably display the symbols in a second column, which is other than the first column, in the vertical direction if the second game is executed.

### CROSS REFERENCE TO RELATED APPLICATIONS

This application is based upon and claims the benefit of priority from the prior Japanese Patent Application No. 2005-376231, filed on Dec. 27, 2005; the entire contents of which are incorporated herein by reference.

### BACKGROUND OF THE INVENTION

1. Field of the Invention

The present invention relates to a gaming machine and particularly to a gaming machine which provides variable display of symbols and pays out gaming values when a specific symbol is stopped on an activated line.

2. Related Background of the Invention

There exist a large number of so-called slot machines. This type of gaming machine variably displays symbols by rotating a reel (drum) on which a plurality of symbols are attached and determines presence of winning, contents of payout due to the winning, and the like according to the symbols located at a specific position (on the activated pay line or the like) when finishing the variable display of the symbols.

In a gaming machine for playing a slot game in general, the symbols are varied in the vertical direction (longitudinal direction) but in this type of gaming machines, such a gaming machine is proposed in which a reel rotating in the vertical direction and a reel for horizontal rotation are provided for variation of symbols in the vertical direction as well as in the horizontal direction (as described in Japanese Patent Application Laid-Open No. Hei 6-269545 (for example, in paragraphs [0023] to [0024])).

### SUMMARY OF THE INVENTION

An object of the present invention is to provide a gaming machine which can variably displays symbols by vertical rotation and horizontal rotation and is capable of unprecedented change in variation of symbols which can not be found in existing slot machines.

The present invention provides a gaming machine for playing a first game where winning is determined based on stopped symbols when variable display of symbols is ended and a second game executed when stopped symbols in the first game satisfies a predetermined condition. The gaming machine comprising: a symbol display means having a symbol display area in which areas respectively displaying symbols are arranged in a matrix shape; and a variable display control means for controlling the symbol display means to variably display the symbols in the symbol display area, wherein, in the first game, the variable display control means controls the symbol display means to variably display the symbols in each column of the symbol display area in the vertical direction, and in the second game, the variable display control means controls the symbol display means to variably display the symbols at least in one column of the symbol display area in the horizontal direction, and to variably display the symbols in the other columns in the vertical direction.

### BRIEF DESCRIPTION OF THE DRAWINGS

FIG. 1 is a perspective view of a slot machine.

FIG. 2 is an enlarged view of a control panel.

FIG. 3 is a block diagram showing an internal construction of a slot machine.

FIG. 4 is a block diagram showing a construction example of an image control circuit.

FIG. 5 is a view showing a display screen example displayed on the display.

FIG. 6 is a view showing types of symbols displayed in each symbol area of a symbol display portion.

FIG. 7 shows examples of a pay line of the slot machine; specifically, (a) is a diagram showing an example of a pay line of the slot machine, and (b) is a diagram showing an example of another pay line.

FIG. 8 is a diagram showing an example of symbol rows set in advance for each row.

FIG. 9 is a flowchart showing an example of a main process.

FIG. 10 is a flowchart showing an example of a base game process.

FIG. 11 is a flowchart showing an example of a bonus game process.

FIG. 12 is a view showing a screen example displayed on the display in the base game process.

FIG. 13 is a view showing a screen example displayed on the display in the base game process.

FIG. 14 is a view showing a screen example displayed on the display in a bonus game symbol movement staging process.

FIG. 15 is a view showing a screen example displayed on the display in a bonus game symbol movement staging process.

FIG. 16 is a view showing a screen example displayed on the display in the bonus game process.

FIG. 17 is a view showing an example of symbol types of horizontal symbols.

FIG. 18 is a view showing a screen example displayed on the display in the bonus game process.

FIG. 19 is a view showing a screen example displayed on the display in the bonus game process.

### DESCRIPTION OF THE PREFERRED EMBODIMENTS

Embodiments according to the present invention will be described below in detail referring to the attached drawings. The same or equivalent elements are given the same reference numerals and any duplicated description will be omitted.

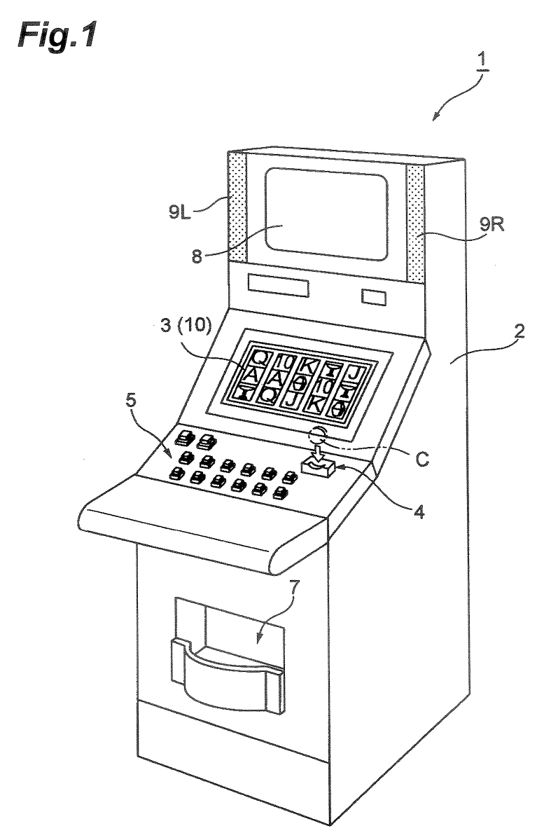

FIG. 1 is an entire perspective view showing a slot machine, which is a gaming machine according to the first embodiment. A slot machine 1 has a cabinet 2, and in the cabinet 2 is provided a display 3, which is a symbol display means. The display 3 is a liquid crystal display for digital display of a slot game, for example.

On the surface of the display 3, a transparent touch panel sensor 10 is provided so that when a player touches a button or the like displayed on the display 3 with a finger or the like, the transparent touch panel sensor 10 detects this contact position to enable input according to the button. The display 3 functions as a symbol display means of the present invention.

In the front below the display 3, a coin insertion portion 4 is provided into which a coin is inserted. A bill insertion portion may be provided as appropriate so that a slot game can be played by bills.

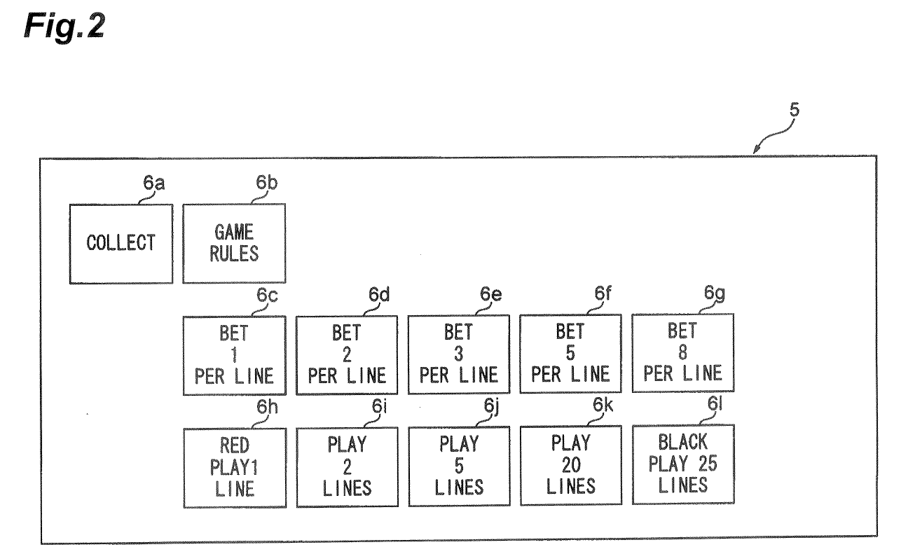

Below the display 3, a control panel 5 is provided. This control panel 5 is substantially the same as those provided in known slot game machines and has 12 buttons 6a to 61 as shown in FIG. 2.

That is, in the upper left of the control panel 5, a collect button (COLLECT) 6a for determining coins gained in the game and a game rule button (GAME RULES) 6b for instructing execution of help function are provided. The remaining 10 buttons are arranged in two rows substantially at the center of the control panel 5 and constituted by five bet buttons 6c to 6g for determining the number of bet coins (bet number) and five line buttons 6h to 61 for determining the number of lines.

Returning to FIG. 1, the description of the slot machine 1 will be continued.

At a lower part of the cabinet 2, a coin receiving portion 7 for a player to receive paid out coins is provided. On the other hand, at an upper part of the cabinet 2, a sub display 8 displaying an image not directly relating to the game (description of the game content, staging of a bonus game and so on) is provided. At the upper part of the cabinet 2, a pair of speakers 9L, 9R are provided on both sides of the sub display 8.

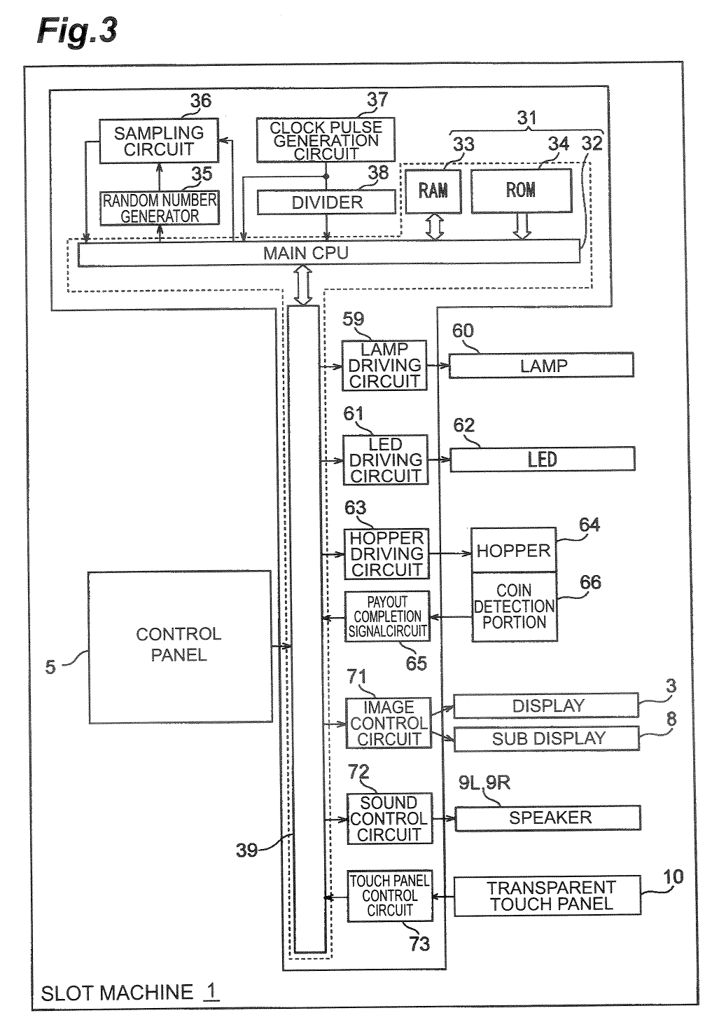

FIG. 3 is a block diagram showing an internal construction of the slot machine 1. As shown in FIG. 3, the slot machine 1 is provided with a plurality of constituent elements around a microcomputer 31.

The microcomputer 31 has a main CPU (Central Processing Unit) 32, a RAM (Random Access Memory) 33, and a ROM (Read Only Memory) 34.

The main CPU 32 functions according to a program stored in the ROM 34, receives an input signal from each portion of the control panel 5 through an I/O port 39 and receives an input signal of a contact position detection signal from the transparent touch panel sensor 10 through a touch panel control circuit 73, while inputting/outputting signals with other constituent elements to execute operation control of the entire slot machine 1. The main CPU 32 (or the microcomputer 31) functions as a processor (for variable display control means) of the present invention.

In the RAM 33, data and programs used when the main CPU 32 functions are stored, and random number values sampled by a sampling circuit 36, which will be described later, are temporarily held after start of a game, for example. The ROM 34 stores programs executed by the main CPU 32 and permanent data.

Also, the slot machine 1 has a random number generator 35, the sampling circuit 36, a clock pulse generation circuit 37, and a divider 38. The random number generator 35 functions according to the instruction of the main CPU 32 and generates a certain range of random numbers. The sampling circuit 36 extracts an arbitrary random number among the random numbers generated by the random number generator 35 according to the instruction of the main CPU 32 and inputs the extracted random number to the main CPU 32. The clock pulse generation circuit 37 generates a reference clock used in the main CPU 32, and the divider 38 inputs a signal obtained by dividing the reference clock by a certain cycle to the main CPU 32.

Moreover, the slot machine 1 has a lamp driving circuit 59, a lamp 60, an LED driving circuit 61, an LED 62, a hopper driving circuit 63, a hopper 64, a payout completion signal circuit 65, and a coin detection portion 66. Also, the slot machine 1 has an image control circuit 71 for executing control process of an image to be displayed on the display 3 and the sub display 8 and a sound control circuit 72 for controlling sound to be generated by the speakers 9L, 9R.

The lamp driving circuit 59 outputs a signal to light the lamp 60 to the lamp 60 and turns on/off the lamp 60 during execution of a game. By this light turning on/off, the game is staged.

The LED driving circuit 61 controls flashing display of the LED 62. The LED 62 executes the number-of-credits display, obtained number display and the like.

The hopper driving circuit 63 drives the hopper 64 according to control of the main CPU 32, and the hopper 64 operates to pay out coins as values and has coins paid out from the coin receiving portion 7.

The coin detection portion 66 counts the number of coins paid out by the hopper 64 and notifies data on the counted number value to the payout completion signal circuit 65. The payout completion signal circuit 65 receives data on the coin count number value from the coin detection portion 66 and inputs a signal to notify coin payout completion to the main CPU 32 when the set number data is reached.

The image control circuit 71 controls image display in each of the display 3 and the sub display 8 to variably display images including symbol images, which will be described later, on the display 3 and the sub display 8.

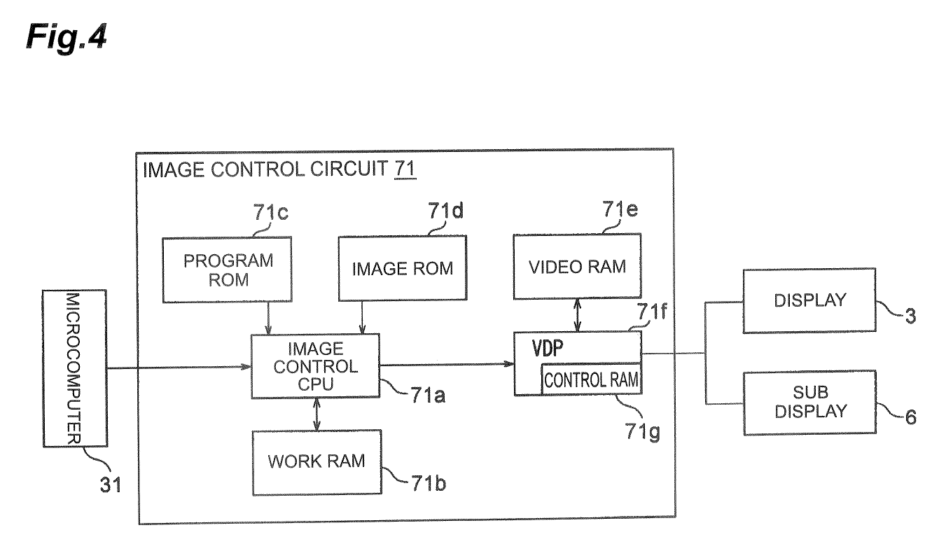

Referring to FIG. 4, a construction example of the image control circuit 71 will be described. FIG. 4 is a block diagram showing a construction example of the image control circuit 71.

This image control circuit 71 has, as shown in FIG. 4, an image control CPU 71a, a work RAM 71b, a program ROM 71c, an image ROM 71d, a video RAM 71e and a VDP (Video Display Processor) 71f. The image control CPU 71a determines an image (symbol image and the like) displayed on the display 3 and the sub display 8 according to an image control program stored in the program ROM 71c in advance based on parameters set in the microcomputer 31. The work RAM 71b is constructed as a temporary storage means when the image control CPU 71a executes an image control program.

The program ROM 71c stores an image control program, various selection tables and the like. The image ROM 71d stores dot data for forming an image. This dot data includes, in this embodiment, data of various symbol images (hereinafter referred to as “symbol image group”). The video RAM 71e is constructed as a temporary storage means for forming an image by the VDP 71f. The VDP 71f has a control RAM 71g, forms an image according to the display contents of the display 3 and the sub display 8 determined by the image control CPU 71a and outputs the respective formed images to the display 3 and the sub display 8.

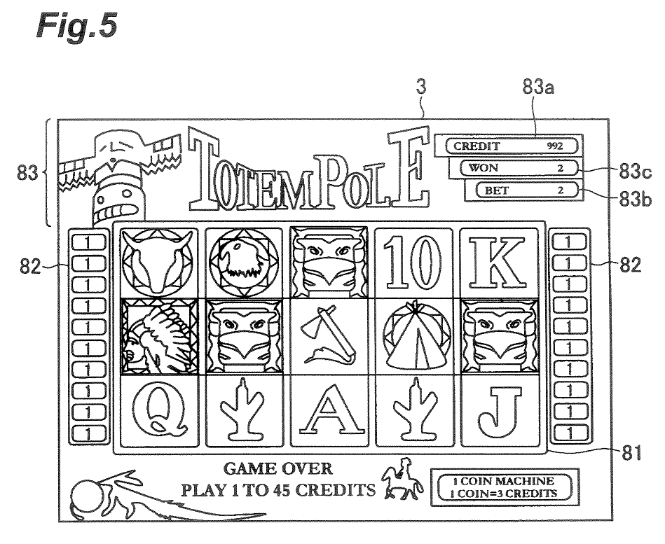

FIG. 5 is a view of a display screen example displayed on the display 3 corresponding to a symbol display means of the present invention. In this embodiment, the display 3 displays a symbol display portion 81 having a symbol area for displaying symbols in a matrix of 5 columns and 3 rows, a line number display portion 82 and an upper display portion 83.

The symbol display portion 81 has symbol areas each for displaying one symbol (may include blank), in a variable display stopped state. The symbol display portion 81 corresponds to a symbol display area of the present invention, and the symbol area corresponds to a small area, which is an area for displaying a symbol.

At execution of a base game corresponding to the first game of the present invention, the three symbol areas belonging to the same column variably display reel images in which a plurality of types of symbols are drawn by the execution of variable display so that a state where general mechanical type slot machine is carrying out reel rotation is reproduced. When the variable display is stopped, the symbols are image-processed to be displayed one by one in the symbol areas.

On both sides of the symbol display portion 81, the line number display portions 82 displaying line numbers representing each pay line, which is an activated line, is displayed. Among line numbers displayed on the line number display portion 82, the number corresponding to the pay line, which is the activated line selected by the player is displayed in the lighted state, while the number not selected by the player is displayed in the extinguished state.

Above the symbol display portion 81, the upper display portion 83 is formed. This upper display portion 83 consists of a number-of-credits display portion 83a, a number-of-BET display portion 83b, and a number-of-PAID display portion 83c. The number-of-credits display portion 83a displays the number of coins currently credited (saved) in this slot machine 1, and the number-of-BET display portion 83b displays the number of coins BET to a single game. The number-of-PAID display portion 83c displays the number of coins paid out in a single game, that is, the gained credit value.

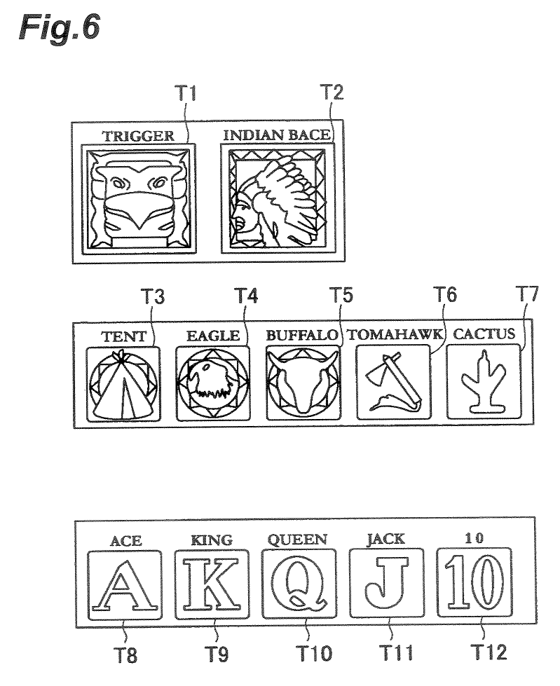

FIG. 6 is a view showing types of symbols displayed in each symbol area of the symbol display portion 81 at execution of a base game. Symbols in this embodiment include bonus symbols, which are a special symbol (symbol showing a totem pole) T1 and a wild symbol (symbol showing a native American) T2, base symbols which are a tent symbol T3, an eagle symbol T4, a buffalo symbol T5, a tomahawk symbol T6, a cactus symbol T7, and 5 types of card mark symbols T8 to T12.

The bonus symbol T1, which is a special symbol, is a symbol (scatter symbol) to be a trigger (condition) to enter (start) the bonus game. The condition to enter the bonus game is, for example, such that when this bonus symbol T1 is displayed one in each row of the symbol display portion 81 (in whichever column), the slot machine 1 starts the bonus game. The bonus game corresponds to the second game of the present invention.

Also, the other special symbol, the wild symbol T2 can replace any of the above-mentioned base symbols, which are the tent symbol T3, the eagle symbol T4, the buffalo symbol T5, the tomahawk symbol T6, the cactus symbol T7, and 5 types of card mark symbols T8 to T12 and it can be considered as an almighty symbol.

The card mark symbols are 5 types of symbols of an ace symbol (“A”) T8, a king symbol (“K”) T9, a queen symbol (“Q”) T10, a jack symbol (“J”) T11 and a numeral symbol (“10”) T12.

Also, a subject to be displayed on the symbol display portion 81 by the slot machine 1 may include a blank symbol. The blank symbol does not display anything in each symbol area of the symbol display portion 81, and it may be treated as one type of symbols or it may be ignored in determination of award winning or shift to a special game as if no symbol exists. The present invention can handle this blank symbol as being included in the “symbol”. In the slot machine handling the blank symbol, even arrangement of symbols with the blank symbol arranged between the above special symbols and/or base symbols also corresponds to “a plurality of consecutive symbols” or “symbol column” in this specification.

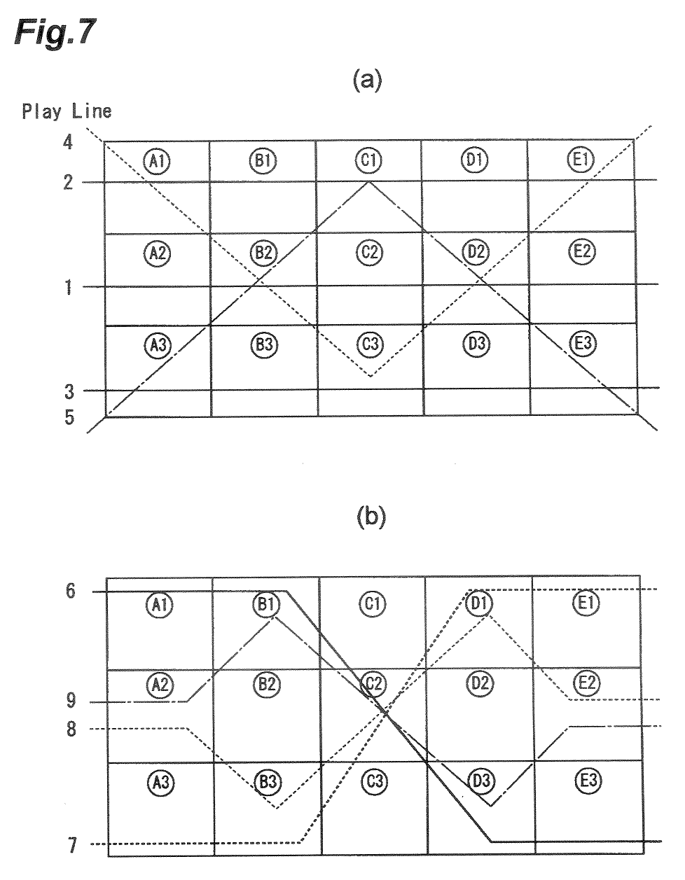

FIG. 7 shows two examples (a) and (b) of pay lines (also called an activated line, award winning line) of the slot machine 1. In order to facilitate understanding, the pay lines are shown in two figures (a) and (b) separately. There are nine pay lines prepared as an example. When a combination of winning symbols, which is a combination of predetermined symbols (three or more same kind of base symbols adjacent to one another, for example) is disposed in any of these pay lines, payout according to the contents of the winning symbol combination is paid out to the player. In the figures, reference characters A1, A2 and A3 denote symbol areas located at the first row to the third row of the leftmost column in the symbol display portion 81, B1, B2 and B3 denote symbol areas located at the first row to the third row on the second column from the left end in the symbol display portion 81, C1, C2 and C3 denote symbol areas located at the first row to the third row on the third column from the left end in the symbol display portion 81, D1, D2 and D3 denote symbol areas located at the first row to the third row on the fourth column from the left end in the symbol display portion 81, and E1, E2 and E3 denote symbol areas located at the first row to the third row on the rightmost column in the symbol display portion 81.

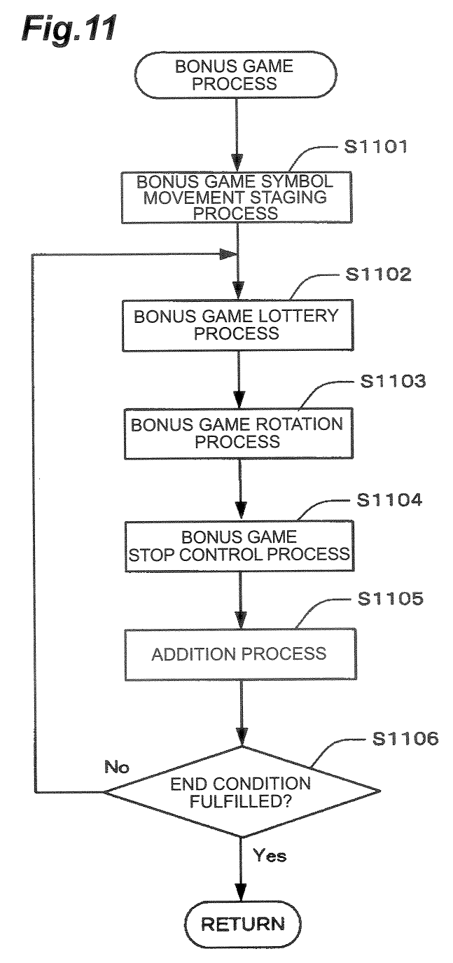

Though not shown, other than those in FIGS. 7(a) and 7(b), 11 pay lines are prepared, totaling in 20 pay lines. In this way, in this embodiment, since there are as many as five columns corresponding to the reels of a normal slot machine, diversified pay lines can be provided.

Among 20 pay lines set in the symbol display portion 81, award winning is determined based on whether or not a combination that the same type of symbols, an example of combination of predetermined symbols, exists on the pay line designated by the player with the line buttons 6h to 61. If the combination of the same type of symbols is aligned on the pay line designated by the player, the main CPU 32 as a determining means determines that the award winning condition is satisfied and has payout of the predetermined number of coins made.

In the award winning determination, the wild symbol T2 is determined as an almighty symbol and treated as an advantageous symbol for payout (number of payouts per coin) among the above ten kinds of symbols. That is, even if only the ace symbol T8 and the wild symbol T2 are aligned in all the symbol display areas in one pay line, coins are paid in the number equal to the case where the ace symbols T8 are aligned in all the symbol display areas in one pay line. In this case, the wild symbol T2 is treated as the ace symbol T8 in that pay line.

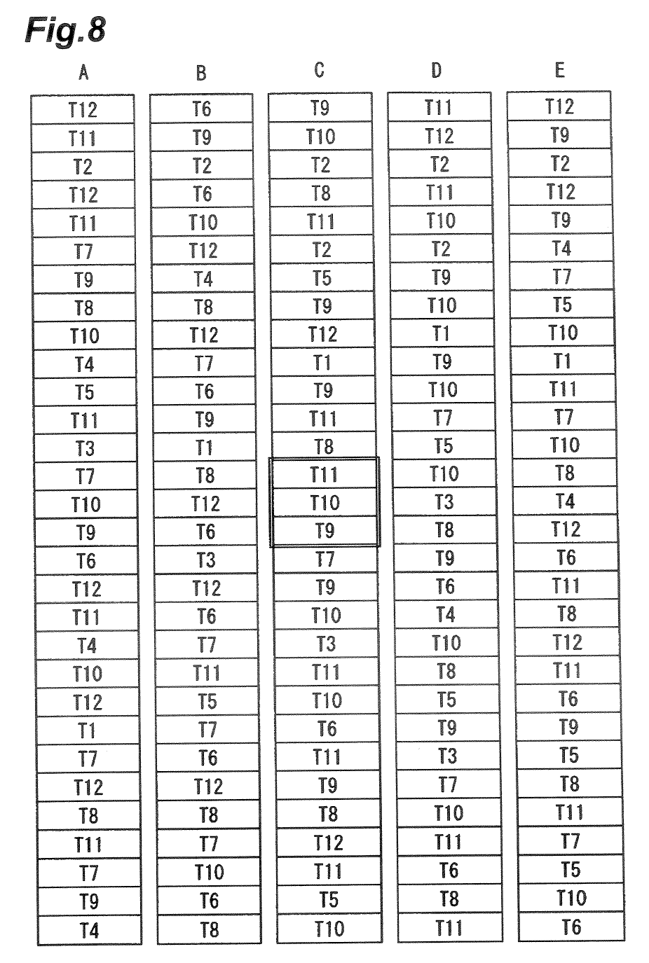

Next, arrangement of symbols (symbol columns) displayed in each column of the symbol display portion 81 during a base game will be described referring to FIG. 8. FIG. 8 is a diagram showing an example of symbol columns determined in advance for each column. In FIG. 8, reference numerals of respective symbols are displayed in place of symbols. In the figure, A denotes a symbol column applied to the leftmost column in the symbol display portion 81, B denotes a symbol column applied to the second column from the left end in the symbol display portion 81, C denotes a symbol column applied to the third column from the left end in the symbol display portion 81, D denotes a symbol column applied to the fourth column from the left end in the symbol display portion 81, and E denotes a symbol column applied to the column on the right end in the symbol display portion 81.

As shown in FIG. 8, at each column, symbols aligned in the predetermined order (referred to as symbol column or symbol arrangement; in this embodiment, each symbol column is assumed to be constituted by 30 symbols, but the number of symbols is not limited to this) are variably displayed in the circulating manner. In this embodiment, scroll display is employed as variable display, but display methods other than scroll display may be employed.

By this scroll display, the player is given perception as if the mechanical type reel is rotated and symbols are varied. The symbol columns of respective columns A to E may be scroll-displayed in the same cycle or in the cycles different from one another.

The slot machine 1 according to this embodiment has a base game state and a bonus game state, which is another game state transited from the base game state. The bonus game corresponds to the second game of the present invention.

The main CPU 32 of the microcomputer 31 determines if the bonus game generation condition is fulfilled or not, and when the bonus game generation condition is satisfied, the bonus game process is executed.

This bonus game generation condition is, as mentioned above, that one bonus symbol T1 is displayed in each row of the symbol display portion 81. The coin payout rate in the bonus game state is set higher than that in the base game state. That is, this bonus game state is an advantageous state for players in payout of coins as compared with the base game state. Therefore, the player will play the base game expecting shift to the bonus game.

Next, an operation example (control method) of the slot machine 1 according to this embodiment will be described.

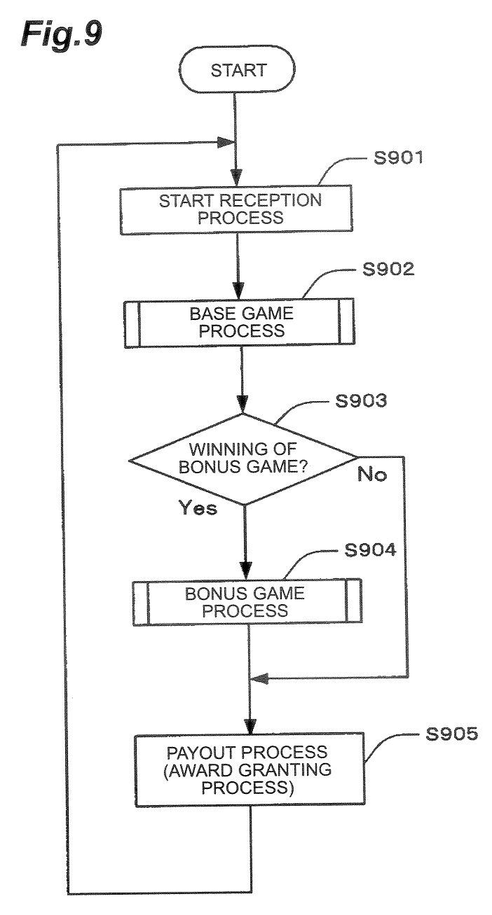

FIG. 9 is a flowchart showing an example of a main process executed by the main CPU 32 of the microcomputer 31 showing an operation example of the slot machine 1. This main process is a process executed when the slot machine 1 is powered on.

The slot machine 1 first executes a start reception process (S901) at start of the game when the main process is started. More specifically, the main CPU 32 accesses the ROM 34 and transfers information relating to the base screen such as a frame displayed on the display 3 to the image control circuit 71, while the image control circuit 71 stores the received information in the video RAM 71e once and then, has it displayed on the display 3. By this, the player becomes capable of playing the slot game provided by the slot machine 1.

The following process is realized when the program stored in the ROM 34 and the RAM 33 is executed by the main CPU 32.

At this Step S901, the slot machine 1 waits for the BET operation (insertion of coins, pressing of the bet button and so on) by the player. Specifically, if coins in the number bet on one game are inserted through a coin insertion slot 4 or if the bet buttons 6c to 6g are pressed when there are credits accumulated in the slot machine 1, the start reception process is completed.

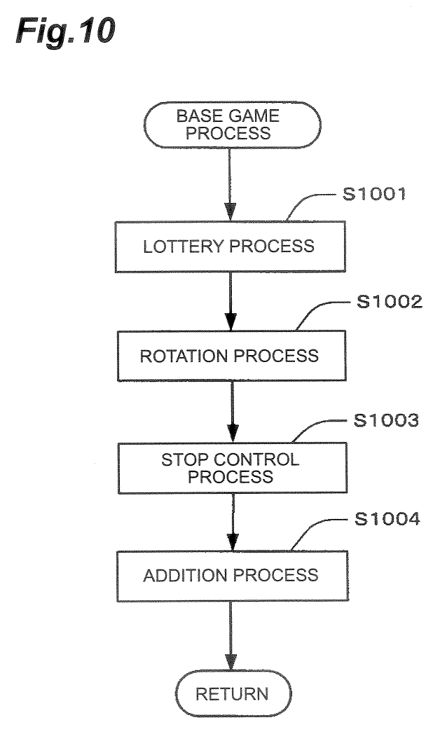

When the start reception process is completed, the slot machine 1 starts the base game process (S902). FIG. 10 shows a flowchart showing an example of the base game process. The example of the base game process will be described below referring to FIG. 10.

In the base game process, first, the slot machine 1, more specifically, the main CPU 32 (hereinafter simply referred to as “main CPU 32”) executes a lottery process (S1001). The main CPU 32 extracts a random number from the sampling circuit 36 and determines if award winning has occurred or not in the base game based on the extracted random number.

Next, the main CPU 32 gives a command to the image control circuit 71 to get the display 3 to scroll-display the symbol column displayed in each row of the symbol display portion 81 (S1002). At this time, the main CPU 32 controls the image control circuit 71 to execute the image process as if the mechanical type reels rotates in the vertical direction. In other words, the main CPU 32 (variable display control means) controls the display 3 (symbol display means) to variably display the symbols in each column of the symbol display area in the vertical direction.

Next, the main CPU 32 determines the symbols to be displayed in the still state in the respective symbol areas in each column after the scroll display is stopped based on the random value extracted in the preceding lottery process (S1001), and executes the stop control process to control the image control circuit 71 so that the determined symbols are displayed in each of the symbol areas in each column when the scroll display is stopped. The state where the scroll display is finished and the symbols are stopped and displayed in the symbol display portion 81 is called “variation stop display state” and the symbols displayed in the symbol display portion 81 in the variation stop display state is called “stopped symbols”.

After the stop control process (S1003), the main CPU 32 executes an addition process (S1004) to add and store a payout amount according to the winning pattern in a predetermined memory area (variable) in the RAM 33 when the award winning is achieved. The value stored in this memory area becomes data to be used in a payout process (award granting process) (S905), which will be described later.

Then, the base game process is finished.

Returning to FIG. 9, the description of the main process will be continued.

When the base game process (S902) is finished, the main CPU 32 determines if a transition condition (it may be an award winning condition of the bonus game) to the bonus game is formed or not (S903). This determination may be made based on the random number extracted in the preceding lottery process (S1001) or on the stopped symbols displayed on the symbol display portion 81 at that time. In this embodiment, suppose that one bonus symbol T1 is displayed as a stopped symbol in each row of the symbol display portion 81 in the variation stop state. When determination is made based on the random number, if the random number value corresponding to the transition condition to the bonus game (it may be an award winning condition of the bonus game) is extracted, the main CPU 32 determines that the transition condition to the bonus game (it may be an award winning condition of the bonus game) is fulfilled, while in the above-mentioned stop control process (S1003), one bonus symbol T1 is displayed as a stopped symbol in each row of the symbol display portion 81 in the variation stop state.

When it is determined that the transition condition to the bonus game (it may be an award winning condition of the bonus game) is formed (S903, Yes), the main CPU 32 executes the bonus game process (S904).

In this bonus game, the scroll display of symbols in the central column of the symbol display portion 81 is executed in the horizontal direction (row direction) while the scroll display of the symbols are executed in the vertical direction (column direction) in the other column. In other words, the main CPU 32 (variable display control means) controls the display 3 (symbol display means) to variably display the symbols at least in one column of the symbol display area in the horizontal direction, and to variably display the symbols in the other columns in the vertical direction.

In the bonus game, too, the variation display stop state is brought about after the scroll display, and the stopped symbols are displayed in the symbol areas of the symbol display portion 81. However, in the central column where the scroll display of symbols is executed in the horizontal direction, symbols other than the symbols T2 to T12 displayed in the symbol areas in the base game are displayed, and the symbols displayed in this central column include the symbols indicating a multiplying factor to determine the credit value to be paid out when the award winning is achieved in the bonus game and the symbols indicating fulfillment of the end condition of the bonus game.

A specific example of the bonus game process will be described below referring to FIG. 11. FIG. 11 is a flowchart showing an example of the bonus game process.

The bonus game process is a process to execute a game different from the base game by the slot machine 1.

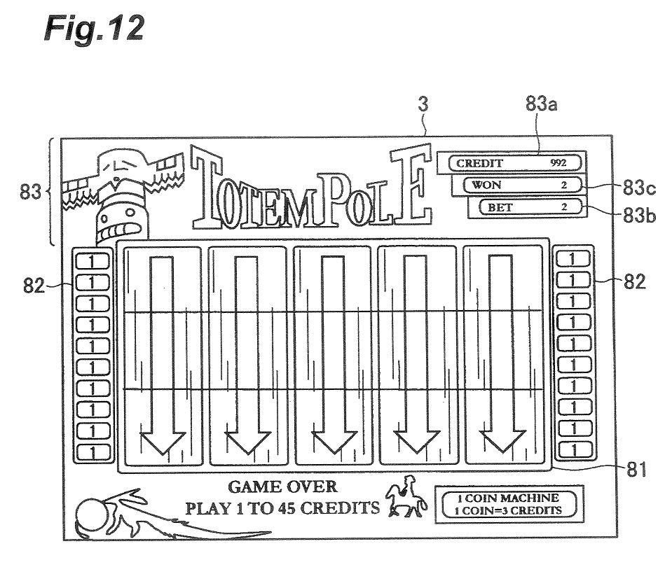

When the bonus game process is started, the main CPU 32 corresponding to the variable display control means of the present invention first executes the bonus game symbol movement staging process (S1101). The bonus game symbol movement staging process is a process of staging to notify the player of start of the scroll display in the bonus game that the bonus symbol T1 displayed in each column is moved to the central column, and scroll display in the horizontal direction is executed in the central column. An example of the bonus game symbol movement staging process will be described below referring to FIGS. 12 to 15.

FIG. 12 is a view showing a screen example displayed on the display 3 during execution of a rotation process (S1002) in the above-mentioned base game. In the symbol display portion 81 displayed on the display 3, scroll display of the symbols in the vertical direction (column direction) is executed in each column. Arrows in the figure show that the symbol columns are in the scroll display.

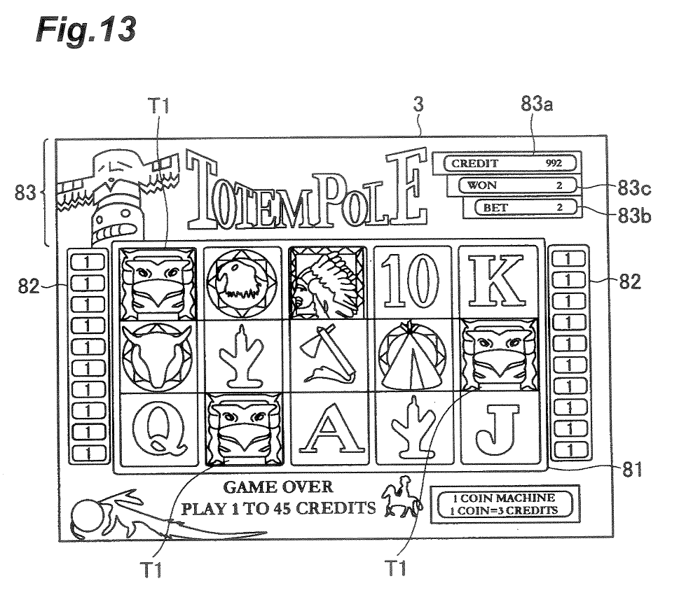

FIG. 13 is a screen example in which the display 3 displays the stopped symbols in each of the symbol areas of the symbol display portion 81 by a stop control process (S1003) after the scroll display shown in FIG. 12. In this screen example, the bonus game transition condition (bonus game winning condition) is fulfilled, and the bonus symbol T1 is displayed in a stopped state (stop-displayed) one in each row.

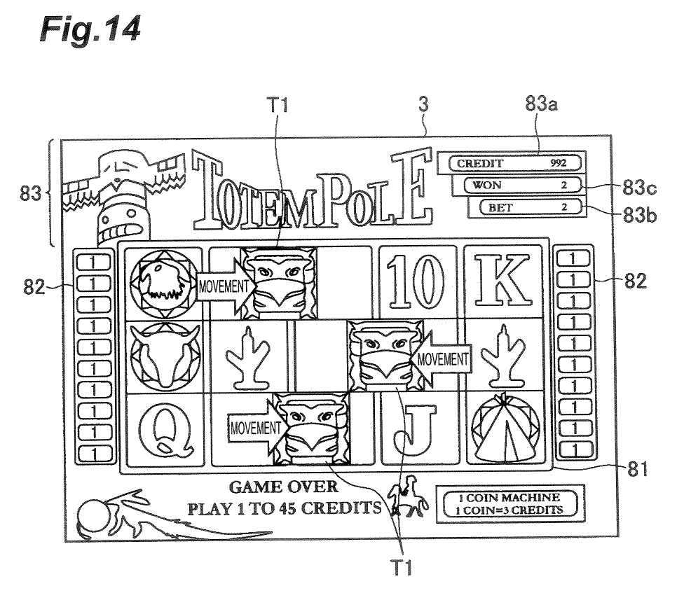

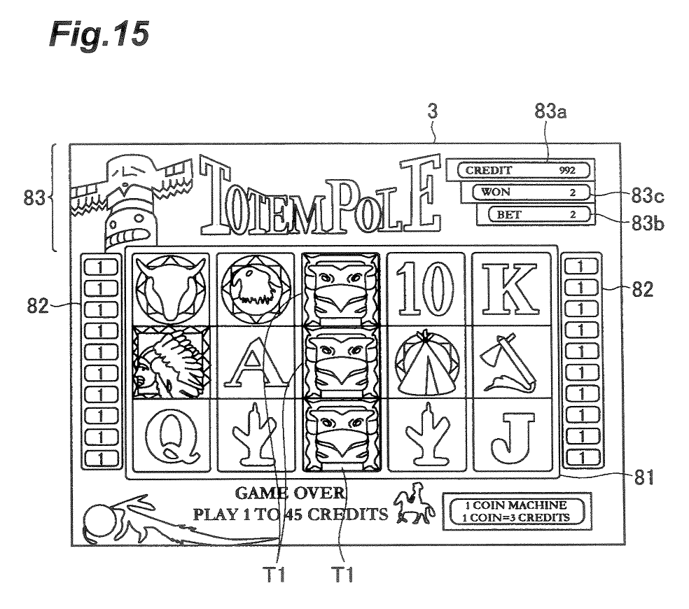

The bonus game symbol movement staging process (S1101) is executed by displaying a screen shown in FIGS. 14, 15 having transited from the screen shown in FIG. 13.

FIG. 14 is a view showing a state where the bonus symbol T1 displayed in a stopped state one in each row starts movement toward the symbol area in the column for scroll-display in the horizontal direction later (the central column in this embodiment).

FIG. 15 is a screen display example displayed after transition from FIG. 14 and is a view showing a state where the bonus symbol T1 which has been displayed in a stopped state one in each row has completed movement to the symbol area in the column for scroll display in the horizontal direction later (the central column in this embodiment). In this embodiment, the bonus symbol T1 is a symbol representing a totem pole, and in the state where the movement has been completed, it is displayed as if a single totem pole is completed.

The main CPU 32 gives a command to the image control circuit 71 to execute staging display as shown in FIGS. 14, 15, and the image control circuit 71 gets the display 3 to execute image display as shown in FIGS. 14, 15 based on the staging pattern stored in advance. This process is the bonus game symbol movement staging process (S1101).

Returning to FIG. 11, the description of the bonus game process will be continued.

After the bonus game symbol movement staging process (S1101), the main CPU 32 executes the bonus game lottery process (S1102). This is a process to determine a stopped symbol (or a combination of stopped symbols) displayed after scroll display is finished in the column for scroll display in the horizontal direction (row direction) and a stopped symbol (or a combination of stopped symbols) displayed after the scroll display is finished in the column for the scroll display in the vertical direction by lottery. Lottery may be drawn by a random number value extracted from the sampling circuit 36 as same as the base game or by means of other methods.

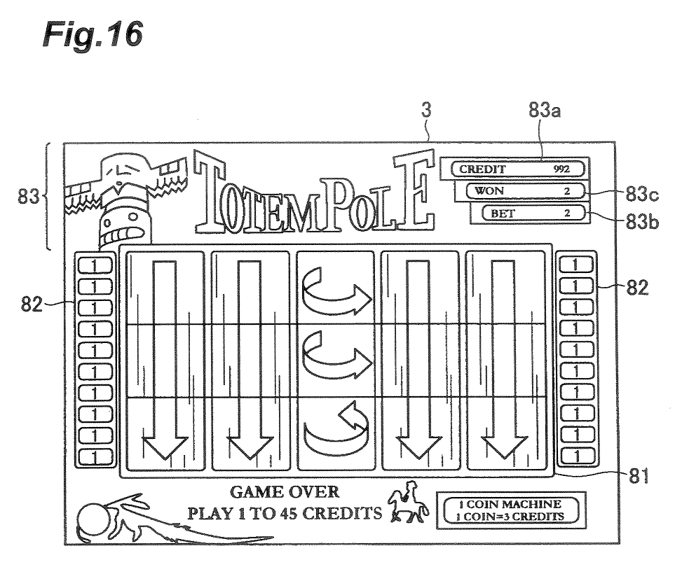

Next, the main CPU 32 executes the bonus game rotation process (S1103) to execute the scroll display in the column for scroll display in the horizontal direction (row direction) and scroll display in a column for scroll display in the vertical direction (column direction). FIG. 16 shows a screen example displayed on the display 3 at execution of the bonus game rotation process. In this example, scroll display of the symbol column is executed as if the symbol column is rotated in the horizontal direction (row direction) in the central column for the scroll display in the horizontal direction (row direction) of the symbol display portion 81, while in the column for scroll display in the vertical direction (column direction), the scroll display is executed as if the symbol column is rotated in the vertical direction (column direction).

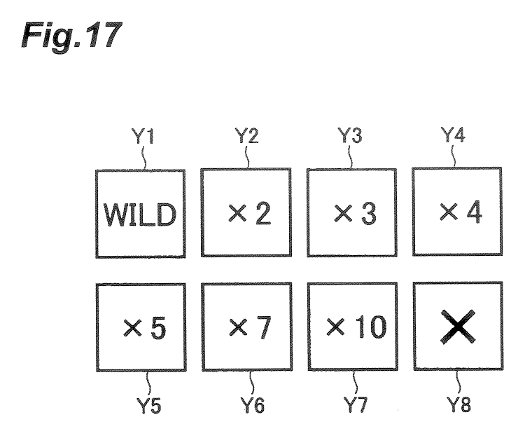

FIG. 17 shows symbols (called horizontal symbols) included in the symbol column (called horizontal symbol column) used for the scroll display of the symbol column in the horizontal direction (row direction). The horizontal symbols are prepared as 8 types of symbols: a wild symbol Y1, a double symbol Y2, a triple symbol Y3, a quadruple symbol Y4, a quintuple symbol Y5, a seven times symbol Y6, and a 10 times symbol Y7 called multiplying factor symbols, and an end condition symbol Y8. The “n-times symbol” (“n” means any number from two to ten) functions as “Wild×n”, that is, a wild symbol and has a role to multiply the payout by n. The multiplying factor symbol functions as a symbol indicating the multiplying factor to determine the gaming value to be paid out at winning in the present invention, and the end condition symbol functions as a symbol indicating that the end condition of the second game is fulfilled.

The horizontal symbol columns are constituted by combining these 8 types of horizontal symbols as appropriate. The horizontal symbol columns do not necessarily have to include all the 8 types of horizontal symbols. Also, it may be so constituted that the scroll display is executed using the same horizontal symbol columns in each row or the scroll display may be executed using different types of horizontal symbol columns in each row.

The wild symbol Y1 is a stopped symbol displayed in the column for the scroll display in the vertical direction and a symbol treated as any of the symbols located on the same activated line, a so-called almighty symbol.

The multiplying factor symbols: a double symbol Y2, a triple symbol Y3, a quadruple symbol Y4, a quintuple symbol Y5, a seven-time symbol Y6, a 10 times symbol Y7, are stopped symbols displayed in a column for the scroll display in the vertical direction, respectively, and when the combination of symbols located on the same activated line as the multiplying factor symbol becomes a winning pattern, the payout set for the winning pattern (called reference payout) is multiplied by the multiplying factor to calculate a final payout (called final payout). For example, if the triple symbol Y3 is displayed in a stopped state in the symbol area corresponding to the central column of a given row and the stopped symbols displayed in the other symbol areas of that row form a winning pattern of the reference payout of five coins, the final payout is determined as 5 coins×3 times=15 coins.

The end condition symbol Y8 is a symbol used for end condition determination of the bonus game. In this embodiment, when this end condition symbol Y8 is displayed in a stopped state in all the rows at the central column, where the scroll display in the horizontal direction is executed, one is added to the bonus game end condition points. The bonus game end condition point is a variable stored in the RAM 33 and a variable cleared to zero at start or end of the bonus game.

Every time this end condition symbol Y8 is displayed in a stopped state in all the rows at the central column, one is added to the bonus game end condition points, and the bonus game end condition points are increased. When the bonus game is continued and the bonus game end condition points reach a predetermined value (five points, for example), it is determined that the bonus game end condition is fulfilled.

On the other hand, the symbol columns used in a column for the scroll display in the vertical direction (column direction) may be the same as those used in the base game (See FIG. 8) or special symbol columns for the bonus game (symbol columns excluding the bonus symbol T1, for example).

Returning to FIG. 11, the description of the bonus game process will be continued.

After execution of the bonus game rotation process, the main CPU 32 executes the bonus game stop control process (S1104). That is, based on the random number value extracted in the preceding bonus game lottery process (S1102), the bonus game stop control process is executed to control the image control circuit 71 so that symbols to be displayed in the still state in the respective symbol areas of each column after end of the scroll display of both in the horizontal direction and the vertical direction are determined and the determined symbols are displayed in the respective symbol areas in each column when the scroll display is stopped (S1104).

Next, when the award winning is achieved, the main CPU 32 executes an addition process (S1105) for adding and storing in a predetermined memory area of the RAM 32, the payout amount according to the winning combination and if the horizontal symbol displayed in the column where the scroll display is executed in the horizontal direction is a multiplying factor symbol, the final payout value calculated by multiplying the factor. The values stored in this memory area become data to be used in the payout process (S905), which will be described later.

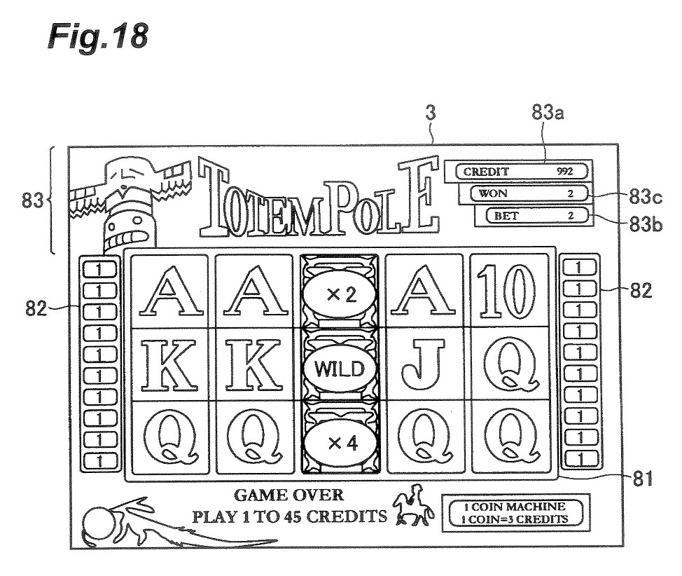

FIG. 18 shows a screen example in the state where the horizontal symbols and the symbols are displayed in a stopped state by the bonus game stop control process. In this example, four card symbols T10 of the same type are aligned in the lowermost row, which forms one winning pattern. Also, in the symbol area in the lowermost row at the central column, the quadruple symbol Y4 is stopped. As a result, the final payout for the lowermost row is a value obtained by quadrupling the reference payout set for the card symbol T10, and this final payout value is added in the addition process. Since no winning pattern is achieved in the middle row and the uppermost row, there is no payout. In the uppermost row, the double symbol Y2 is displayed, but since a winning pattern is not achieved, no effect of multiplying factor symbol is exerted.

Returning to FIG. 11, the description of the bonus game will be continued.

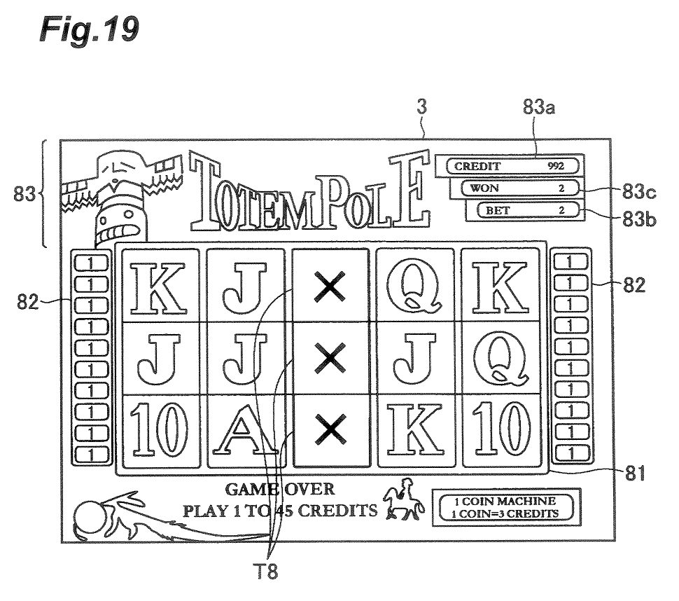

After the addition process (S1105), the main CPU 32 executes determination of the bonus game end condition (S1106). That is, the main CPU 32 determines if the end condition symbol Y8 is displayed in a stopped state in all the rows in the central column, which is a column where scroll display in the horizontal direction is executed, and if it is determined that this end condition symbol Y8 is displayed in a stopped state in all the rows, one is added to the bonus game end points, and it is further determined if the value after the addition has reached a predetermined value or not. If the predetermined value is reached, the main CPU 32 determines that the bonus game end condition is fulfilled, while if the predetermined value is not reached, it determines that the bonus game end condition is not fulfilled. FIG. 19 shows a screen example in which the end condition symbol Y8 is displayed in a stopped state in all the rows. When this screen is displayed, one is added to the bonus game end points.

If it is determined that the bonus game end condition is not fulfilled (S1106, No), the main CPU returns to S1102 and the bonus game is continued. On the other hand, if it is determined that the bonus game end condition is fulfilled (S1106, Yes), the main CPU 32 ends the bonus game process and returns control to the main process.

Returning to FIG. 9, the description of the main process will be resumed.

When the bonus game process (S904) is finished, the main CPU 32 executes a payout process (award granting process) (S905) in which the value added and stored in the addition process (S1104, S1105) is added to credits stored as a variable in the RAM 33 so as to provide the payout obtained in the base game and the bonus game to the player and the whole or a part of the credits are converted to coins, medals and paid out when requested by the player. After that, when the player executes a bet, the process returns to the start reception (S901) again and then, the slot machine 1 repeatedly executes the processes from S902 to S905 similarly so that the base game and the bonus game if the bonus game award is won.

Then, the description of main process is finished.

As described above in detail, according to the present invention, by executing variable display in two different directions at the same time, variable pattern in rich variation can be offered, and such a gaming machine that can improve interest in games can be provided

Specifically, the present invention has the following characteristics.

The present invention is proposed as a gaming machine (a slot machine, for example) in which a player plays a first game (base game, for example) in which presence of winning is determined based on a stopped symbol displayed and a second game (bonus game, for example) executed when the stopped symbol in the first game satisfies a predetermined condition.

This gaming machine has a symbol display means (display, for example) having a symbol display area (symbol display portion, for example) in which small areas, which are areas for displaying symbols, respectively, are arranged in a matrix and a variable display control means (microcomputer or main CPU, for example) for making the symbol display means execute variable display of symbols in the symbol display area, and the variable display control means, in the first game, executes variable display of symbols in each column of the symbol display area in the vertical direction (column direction, for example) and, in the second game, executes variable display of symbols in a first column of the symbol display area in the horizontal direction (row direction, for example), and executes that in the a second column, which are other than the first column, in the vertical direction.

According to the above gaming machine, by executing variable display in two directions by the same symbol display means at the same time, variable patterns with rich variation are offered and interest in the game can be improved.

In the above gaming machine, during the second game, in a column where variable display of symbols are executed in the horizontal direction symbols different from those (symbols in the horizontal direction, for example) displayed in the symbol display area in the first game may be displayed. That is, symbols displayed in the first column during the second game may be different from symbols displayed in a column corresponding to the first column during the first game.

According to this gaming machine, not only variation pattern of symbols but variation of symbols are also made rich, which can further improve interest in games.

In the above gaming machine, symbols displayed in the first column where the symbols are variably displayed in the horizontal direction may include a symbol indicating a multiplying factor (multiplying factor symbol, for example) for determining payout (that is, a gaming value to be paid out upon winning an award).

According to this gaming machine, a chance at which a large quantity of gaming values can be gained can be obtained, which can improve players' desire to play a game.

In the above gaming machine, symbols displayed in the first column where the symbols are variably displayed in the horizontal direction may include a symbol indicating fulfillment of an end condition of the second game (end condition symbol, for example). The “fulfillment of the end condition” here means not only fulfillment of all the conditions but also fulfillment of some of the conditions (increase of bonus game end condition points, for example).

According to this gaming machine, the bonus game end conditions are clearly understood by players, which can provide more thrilling games.

[Variation, others]

The present invention is not limited to the above-mentioned embodiment, and various modifications are possible as follows:

(1) The number of columns where the scroll display is executed in the horizontal direction is not limited to one, but the present invention may be realized by scroll display in the horizontal direction in a plurality of columns.

(2) In place of the scroll display in the horizontal direction, the present invention may be realized by scroll display in the diagonal direction in the diagonally consecutive symbol areas.

What is claimed is:

1. A gaming machine comprising:
a display having a symbol display area in which areas respectively displaying symbols are arranged in a matrix; and
a processor that is operable to execute a first game and a second game executed if stopped symbol in the first game satisfies a predetermined condition, the processor being operable with the display to:
(a) variably display the symbols in each column of the symbol display area in a vertical direction if the first game is executed; and
(b) variably display the symbols in a first column of the symbol display area in a horizontal direction, and variably display the symbols in a second column, which is other than the first column, in the vertical direction if the second game is executed.

2. The gaming machine according to claim 1, wherein symbols displayed in the first column during the second game are different from symbols displayed in a column corresponding to the first column during the first game.

3. The gaming machine according to claim 1, wherein the symbols displayed in the first column where the symbols are variably displayed in the horizontal direction include a symbol indicating a multiplying factor for determining payout.

4. The gaming machine according to claim 1, wherein the symbols displayed in the first column where the symbols are variably displayed in the horizontal direction include a symbol indicating fulfillment of an end condition of the second game.
